(19) United States
(12) Patent Application Publication
(10) Pub. No.: US 2011/0065409 A1
(43) Pub. Date: Mar. 17, 2011

(54) FREQUENCY SHIFTING BASED INTERFERENCE CANCELLATION DEVICE AND METHOD

(76) Inventor: Peter Kenington, Devauden (GB)

(21) Appl. No.: 12/561,594

(22) Filed: Sep. 17, 2009

(51) Int. Cl. H04B 1/10

(52) U.S. Cl. 455/307

(57) ABSTRACT

An interference cancellation device comprises an input for a disturbed signal, a first frequency shifter, a bandpass filter, and a signal combiner. The first frequency shifter shifts the disturbed signal from an original frequency range to a filtering frequency range. The frequency-shifted signal is filtered by the bandpass filter. The filtered signal is supplied to the signal combiner which combines the filtered signal with the disturbed signal to substantially reduce the interference signal that is present in the disturbed signal. A method for interference signal cancellation is also proposed. Furthermore, a computer program product with instructions for the manufacture and a computer program product enabling a processor to carry out the method for interference signal cancellation are also proposed.

### CROSS REFERENCE TO OTHER APPLICATIONS

The present application is related to a patent application entitled “Mismatched delay based interference cancellation device and method” (Attorney Docket No. 4424-P04912US0) filed concurrently herewith. The entire disclosure of the foregoing application is incorporated herein by reference.

### FIELD OF THE INVENTION

The field of the present invention relates to an interference cancellation device, for example for use in a receiver of a base transceiver station of a mobile communications network. The field of the present invention further relates to a method for interference cancellation on a disturbed signal comprising an interference signal. The field of the present invention also relates to a computer program product enabling a foundry to carry out the manufacture of an interference cancellation device, and to a computer program product enabling a processor to carry out the method for interference cancellation.

### BACKGROUND OF THE INVENTION

In a prior art design of radio communication systems the transmitter and the receiver comprise hardware to ensure a certain degree of selectivity in the frequency band. The hardware can be filters, oscillators, mixers or other components. The dedicated hardware allows the transmitter or the receiver to be tuned to a relatively narrow frequency range, often termed “channel”.

A more modern concept is the so-called “software-defined radio system”. In the software-defined radio system, components that have typically been implemented in hardware (e.g. mixers, filters, amplifiers, modulators/demodulators, detectors etc.) are instead implemented using software. The software-defined radio system has become interesting from a commercial point of view when digital circuits with sufficient calculating power became available at reasonable prices. The software-defined radio system makes it possible to use relatively generic electronic components because significant parts of the manner in which a signal is processed can be defined in software. Thus, the software-defined radio system can be, in principle, updated to support new radio protocols or modifications in existing radio protocols.

Software-defined radio systems make use of analogue-to-digital converters or digital-to-analogue converters. The analogue-to-digital converters and the digital-to-analogue converters usually have a limited bandwidth, a limited frequency range and a limited dynamic range. Due to these limitations, the analogue-to-digital converter may not be able to process an incoming analogue signal in the intended manner, such as extracting a wanted signal at a specific frequency within a wideband analogue signal. This inability of the analogue-to-digital converter may be due to an insufficient signal-to-noise ratio or a strong blocker within the frequency range that is observed by the analogue-to-digital converter.

Mobile communications networks are still constantly being developed with the aim to increase the volume of data that can be transmitted in a certain geographic region and within a certain period of time. This development effort may lead to constantly evolving mobile communications standards so that the software-defined radio system appears to be a good choice for an operator of the mobile communications network. Base transceiver stations (BTS) operated by the mobile network operator can be updated and adapted to a number of future mobile communications standards.

A well known standard for mobile communications networks is the GSM standard (Global System for Mobile Communications). The GSM standard has been in use for commercial applications since the early 1990's and continues to be used, at least in some regions. Other standards that may succeed the GSM standard are for example the UMTS and the LTE (Long Term Evolution) standards. The mobile communications standard may define certain tests that the equipment operating under this particular mobile communications standard needs to pass. For example, the GSM standard specifies a blocker test for a GSM receiver. A blocker is a strong interfering signal of which the frequency is close to, or even within, the frequency range of the wanted signal. The GSM specification requires the signal blocker at −16 dBm or −25 dBm be handled. At a level of −16 dBm a noise figure of 9 dB is permitted. This allows an attenuator to be switched in to reduce the blocker level. In the other case the blocker level is reduced to −25 dBm and the relaxation of using an attenuator is no longer permitted.

U.S. Pat. No. 7,551,910 issued to Darabi describes translation and filtering methods for wireless receivers. A method according to the '910 patent may include receiving an input signal within a first frequency range (e.g., RF). The input signal may include a desired signal and a blocker signal. The method may also include down-converting the input signal to a second frequency range (e.g., IF) that is lower than the first frequency range, separating the blocker signal from the desired signal (e.g., at the second frequency range), up-converting the separated blocker signal to the first frequency range (e.g., RF), and subtracting the up-converted blocker signal from the input signal. For separating the blocker signal from the desired signal the '910 patent uses a high-pass filter which will force the overall system to remove all of the signals (both the blocker signals and desired signals) falling within the high-pass filter's pass-band. The method disclosed in the '910 patent only deals with one or more out-of-band blocker signals and cannot deal with in-band blocker signals which are buried in amongst one or more wanted signals. The use of a high-pass filter in the '910 patent precludes a successful cancellation of in-band blocker signals. The entire disclosure of U.S. Pat. No. 7,551,910 is incorporated herein by reference.

### SUMMARY OF THE INVENTION

It would be desirable to have an interference cancellation device for cancelling a blocker or interference signal wherein the interference cancellation device would be tailored to a type of blocker or interference signal that is likely to be encountered. It would also be desirable that such an interference cancellation structure would affect a wanted signal as little as possible, for example substantially only in a frequency range that is heavily disturbed by the blocker signal anyway.

The interference cancellation device of the disclosure comprises an input, a first frequency shifter, a bandpass filter, and a signal combiner. The input is adapted to receive a disturbed signal which includes an interference signal. The first frequency shifter shifts the disturbed signal from an original frequency range to a filtering frequency range, resulting in a frequency-shifted signal. The band pass filter filters the frequency-shifted signal, resulting in a cancellation signal. The band-pass filter has a filter bandwidth substantially equal to an expected bandwidth of the interference signal. The signal combiner combines the disturbed signal with the cancellation signal to substantially reduce the interference signal in the disturbed signal.

The interference cancelation device of the disclosure makes it possible to use a band pass filter with a well-defined centre frequency and bandwidth. The band pass filter does not need to be adjustable. Instead of tuning the band pass filter to the frequency of the interference signal, the entire disturbed signal including the interference signal is frequency-shifted to the filtering frequency range so that the centre frequency of the interference signal and the centre frequency of the band pass filter coincide or are substantially close to each other. In many practical applications, the bandwidth of the blocker or interference signal is known. For example, a blocker signal caused by a nearby base transceiver station operating under the Global System for Mobile communications (GSM) standard has a well-defined bandwidth that is known from the specification of the GSM standard. With the proposed interference cancelation device it is possible to extract a specific blocker signal from a specific system. The blocker cancelation device targets an in-band blocker signal, using a blocker-specific filter, which is possible because the characteristics of the potential blocker signal (notably its bandwidth) may be well known. Therefore, the proposed interference cancelation device is able to deal with in-band blocker signals or out-of-band blocker signals, whereas previous methods only dealt with one or more out-of-band blocker signals and cannot deal with in-band blocker signals which are buried in amongst one or more wanted signals.

The interference cancelation device may further comprise a second frequency shifter for shifting the cancelation signal from the filtering frequency range to the original frequency range. The second frequency shifter brings the substantially isolated cancelation signal back to the original frequency range so that a cancelation between the cancelation signal and the interference signal may be performed. Another possibility would be to shift the disturbed signal to the filtering frequency range, too, and to perform the cancelation of the cancelation signal and the interference signal at the filtering frequency range. Yet a third possibility would be to perform the cancelation of the cancelation signal and the interference signal at a third frequency range, for example at a base band frequency or a frequency at which a digital signal processor (DSP) operates to perform various signal processing tasks.

The first frequency shifter may be a mixer. A mixer usually mixes a mixer input signal with a local oscillator signal. Depending on the frequency of the local oscillator signal, the mixer input is shifted (actually “mirrored”) in the frequency domain. The frequency of the local oscillator signal can usually be adjusted relatively easily and accurately.

When there is a first frequency shifter and a second frequency shifter both of the first frequency shifter and the second frequency shifter may be mixers and the interference cancelation device may further comprise a local oscillator for supplying a local oscillator signal to the first frequency shifter and the second frequency shifter. The use of a single local oscillator serving both the first frequency shifter and the second frequency shifter reduces cost, size and weight of the interference cancelation device. Furthermore, it ensures that the cancelation signal is substantially exactly shifted back to the first frequency range.

The interference cancelation device may further comprise at least one of a gain controller and a phase controller for adjusting at least one of an amplitude and a phase of the cancelation signal. The disturbed signal and the cancelation signal may have undergone different delays and attenuations before the disturbed signal and the cancelation signal reach the signal combiner. To achieve a satisfactory cancelation performance the amplitude and/or the phase of the cancelation signal may be adjusted for better matching the amplitude and/or the phase of the interference signal that is present in the disturbed signal. The delays between the two paths should be matched or nearly matched if the interference signal is a broadband interference signal, such as WiMAX or LTE. A good match of the delays between the two paths is usually less important for an interference signal having a narrowband nature, such as a GSM signal.

It would be desirable that the interference cancelation device could react to different blocker signals or interference signals. To address this concern and/or possible other concerns, the interference cancelation device may further comprise a cancelation controller for adjusting at least one of an amount of frequency shift performed by the first frequency shifter, a gain setting of the gain controller, and a phase setting of the phase controller. The cancelation controller may coordinate various control parameters such as the amount of frequency shift, the gain setting and/or the phase setting. The cancelation controller might be adapted to analyse a signal issued by the signal combiner (or a subsequent signal generated for example by an analogue-to-digital converter). Such an analysis might provide information about the existence of one or several blocker signals and their properties. In combination with a knowledge of the properties of the band pass filter, the cancelation controller may determine the required amount of frequency shift, the gain control setting and/or the phase control setting. The cancelation controller might also implement a successive approximation algorithm for gradually improving the parameters of the interference cancelation device.

The cancelation controller may comprise an input for the cancellation signal. In this manner the cancelation controller may compare the cancelation signal with the signal issued by the signal combiner. For example, the cancelation controller may determine whether a portion of the interference signal is still present and detectable in the signal issued by the signal combiner. In actual applications of the proposed interference cancelation device the cancelation signal may be assumed to be a sufficiently good approximation of the interference signal if the interference cancelation device is adjusted to the interference signal.

The cancelation controller may comprise a correlator for correlating the cancelation signal and a signal originating from the signal combiner. The signal originating from the signal combiner may be the signal directly issued by the signal combiner or a signal having undergone further processing. A correlation between the cancelation signal and the signal originating from the signal combiner provides a measure of the similarity between the cancelation signal and the signal originating from the signal combiner, that is whether the signal originating from the signal combiner comprises a portion that substantially matches the cancelation signal (with possible differences in magnitude and phase). The cancellation controller may adjust the amount of frequency shift, the gain control setting and/or the phase control setting when the signal originating from the signal combiner still comprises a portion that substantially matches the cancellation signal.

The correlator may be one of a quadrature correlator, a polar correlator, and a polar detector. The correlator may be configured in either a polar or a Cartesian format.

The interference cancelation device may further comprise a cancelation controller for adjusting an amount of frequency shift performed by the first frequency shifter. The cancelation controller may comprise an input for the cancelation signal and/or a correlator for correlating the cancelation signal and a signal originating from the signal combiner. The correlator may be a quadrature correlator.

It would be desirable that in a receiver structure having a plurality of similar or identical receive paths, such as in a receiver structure connected to an antenna array, interference signal cancelation could be achieved for all of the receive paths and with little structural overhead. This concern and/or possible other concerns are addressed by the interference cancelation device further comprising a signal splitter for distributing the cancelation signal to a plurality of signal processing paths subject to a similar or identical interference signal. By using a signal splitter on the cancelation signal, the cancelation signal needs to be generated only once for the entire antenna array or for a part of the antenna array. Thus, some of the components mentioned above are required only once, for example the first frequency shifter and the band pass filter.

The interference signal may be an in-band blocker or an out-of-band blocker. An in-band blocker is defined as an unwanted signal which is outside of the control of the operator or owner of the receiver equipment which suffers the interference, but is within the intended (designed) reception frequency range of that receiver equipment. An out-of-band blocker is an unwanted signal which is outside of the control of the operator or owner of the receiver equipment which suffers the interference, and is also outside of the intended (designed) reception frequency range of that receiver equipment. Such signals, if sufficiently strong, can still break through the filtering processes in the receiver and disturb its ability to demodulate the wanted signals.

By means of an example, the ratio between the bandwidth of the interference signal and bandwidth of the disturbed signal may be between 0.5% and 1%. As can be seen, the bandwidth of the interference signal may be relatively narrow when compared to the bandwidth of the disturbed signal.

In the above example, the bandwidth of the interference signal may be between 150 kHz and 300 kHz and the bandwidth of the disturbed band of signals may be between 30 MHz and 40 MHz, with individual signals within that band having bandwidths of between 3.84 and 10 MHz. So-called wideband receivers that are used in mobile communications networks usually have a bandwidth of about 35 MHz. On the other hand, a typical GSM channel has a bandwidth of approximately 200 kHz. When a wideband receiver that is implemented as a software-defined radio is used as a GSM receiver, it needs to comply with the GSM standard. For example, the GSM receiver needs to successfully pass the so called GSM blocker test (as discussed above). The bandwidth of the band pass filter may also be between 150 kHz and 300 kHz to match the bandwidth of the interference signal that the band pass filter tries to extract from the disturbed signal.

The interference cancelation device may further comprise a cancelation signal splitter and additional signal combiners for combining the cancelation signal with other disturbed signals comprising similar or identical interference signals to substantially reduce the similar or identical interference signals in the other disturbed signals. If necessary, at least some of the additional signal combiners may be accompanied by gain controllers and/or phase controllers (possibly one gain controller and/or phase controller per additional signal combiner) so that the gain and phase of the cancelation signals in the additional signal combiners can be substantially matched to the interference signals that arrive at the respective additional signal combiners. The cancellation controller may provide individual control to each of the gain controllers and/or phase controllers accompanying the additional signal combiners.

The present disclosure further describes a method for interference cancelation on a disturbed signal comprising an interference signal. The disturbed signal is frequency shifted from an original frequency range to a filtering frequency range, resulting in a frequency-shifted signal. The frequency-shifted signal is band pass filtered, resulting in a cancelation signal, wherein a bandwidth of the band pass filtering substantially matches an expected bandwidth of the interference signal. The disturbed signal is then combined with the cancelation signal to substantially reduce the interference signal in the disturbed signal.

The method may further comprise frequency shifting the cancelation signal from the filtering frequency range to the original frequency range. The action of frequency shifting may be performed by mixing the disturbed signal or the cancelation signal with a local oscillator signal. In case both frequency shifting actions are performed, that is frequency shifting the disturbed signal to the filtering frequency range and frequency shifting the cancelation shifting back to the original frequency range. Both frequency shifting actions may be mixing actions based on the same local oscillator signal.

The method may further comprise controlling at least one of a gain and a phase of the cancelation signal.

The method may further comprise an action of adjusting at least one of an amount of frequency shift performed by means of frequency shifting the disturbed signals from the original frequency range to the filtering frequency range, a gain setting of the cancellation signal, and a phase setting of the cancellation signal.

The method may further comprise correlating the cancelation signal and a signal resulting from the combining of the disturbed signal with the cancellation signal. The correlation may be a quadrature correlation or a polar correlation (or detection) and may be configured in either a polar or a Cartesian format.

The method may further comprise distributing the cancelation signal to a plurality of signal processing paths subject to a similar or identical interference signal.

The interference signal may be an in-band blocker signal or an out-of-band blocker signal.

By means of an example, the ratio between the bandwidth of the interference signal and a bandwidth of the disturbed signal may be between 0.5% and 1%. The bandwidth of the interference signal may be between 150 kHz and 300 kHz and the bandwidth of the disturbed signal may be between 30 MHz and 40 MHz.

The method may further comprise combining the cancelation signal with other disturbed signals comprising similar or identical interference signals to substantially reduce the similar or identical interference signals in the other disturbed signals.

The present disclosure further provides a computer program product embodied on a computer-readable medium and the computer-readable medium comprising executable instructions for the manufacture of an interference cancelation device as described herein.

The present disclosure also provides a computer program product comprising instructions that enable a processor to carry out the method for interference cancelation as described herein.

As far as technically meaningful, the technical features disclosed herein may be combined in any manner. The interference signal cancelation device and the method for interference cancelation may be implemented in software, in hardware, or as a combination of both software and hardware.

### BRIEF DESCRIPTION OF THE DRAWINGS

FIG. 1 shows a receiver arrangement with an interference signal cancelation device according to a first possible configuration.

FIG. 2 shows a receiver arrangement with an interference signal cancelation device according to a second possible configuration.

FIG. 3 shows a receiver arrangement with a common interference signal cancelation device.

FIG. 4 shows a multi-receiver arrangement with a common interference signal cancelation device according to a second possible configuration.

FIG. 5 shows a multi-receiver arrangement with a common interference signal cancelation device including cancelation signal analysis.

FIG. 6 shows a receiver arrangement with two interference cancellation devices.

FIG. 7 shows a flowchart of one possible algorithm for adjusting various parameters of the interference signal cancelation device or method.

FIG. 8 shows a quadrature correlator that may be used to compare the cancelation signal with a signal in which the interference signal has been substantially cancelled.

### DETAILED DESCRIPTION OF THE INVENTION

The invention will now be described on the basis of the drawings. It will be understood that the embodiments and aspects of the invention described herein are only examples and do not limit the protective scope of the claims in any way. The invention is defined by the claims and their equivalents. It will be understood that a feature of one aspect can be combined with features of a different aspect or aspects.

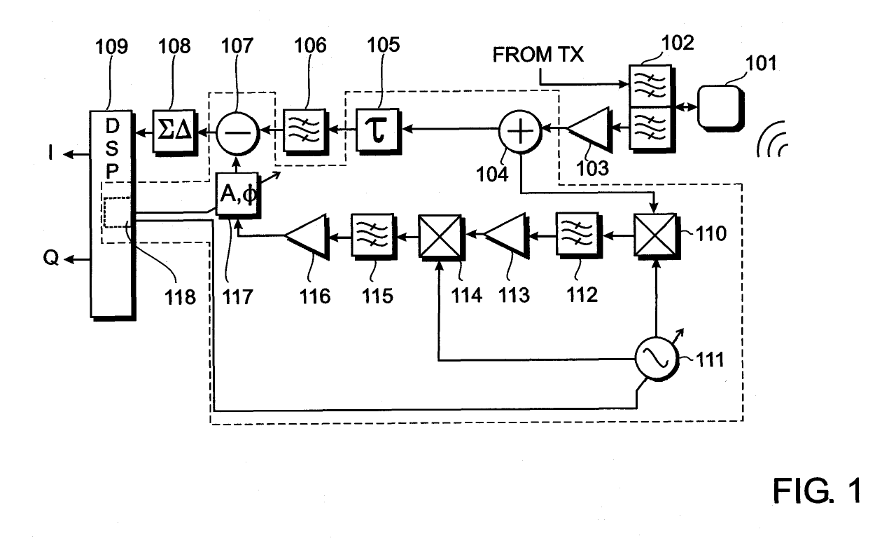

FIG. 1 shows a receiver arrangement or a receive path that may be used in a base-station of a mobile communications network. A signal from a remote transmitter is received at an antenna 101. The antenna 101 is connected to a duplex filter 102 that separates a transmission path from the receive path in the frequency domain. Instead of the duplex filter 102, other techniques may be used, such as a circulator or time multiplexing. The signal arriving from the transmission path is illustrated as an input to an upper part of the duplex filter 102. A lower part of the duplex filter 102 filters the part of the spectrum that is reserved for a receive band of the base-station in the mobile communications network. The duplex filter 102 is connected to a low noise amplifier (LNA) 103 that amplifies the filtered antenna signal to a level at which further signal processing may be performed. An output of the low noise amplifier 103 is connected to a signal splitter 104. The signal splitter 104 distributes a signal received from the LNA 103 to a main processing path and to a filtering path. The main signal processing path is depicted in FIG. 1 as an upper signal processing path and extends between the signal splitter 104 and a signal combiner 107 via a delay element 105 and a band pass filter 106. The filtering path is the lower signal processing path in FIG. 1 and comprises a first mixer or down-conversion mixer 110, a blocker-specific single-carrier band pass filter 112, a buffer amplifier 113, a second mixer or up-conversion mixer 114, a receive-bandpass filter 115, and a further buffer amplifier 116. The first mixer 110 and the second mixer 114 receive a local oscillator signal from a local oscillator 111. The signal processed within the filtering path is down converted to suitable intermediate frequency IF by means of the first mixer 110 which serves as a first frequency shifter. At the intermediate frequency IF the blocker-specific single-channel filter 112 can be placed which is, for example, fabricated using surface acoustic wave (SAW) technology. The signal is filtered, with the channel so-extracted being determined by the frequency to which the local oscillator 111 is tuned. At the output of the blocker-specific single-channel band pass filter 112 substantially only the interference signal is present. The buffer amplifier 113 may not be absolutely necessary but helps to compensate for possible losses within the blocker-specific single-channel band pass filter 112.

The extracted interference signal is then up-converted back to its original frequency in the second mixer 114. The up-converted extracted interference signal is fed to a gain/phase control module 117. In the alternative, a vector modulator may be used instead of the gain/phase control module 117. The gain/phase module 117 adjusts the amplitude and phase of the extracted interference signal to subtract the extracted interference signal from the signal processed by the main signal processing path. In the main signal processing path the delay element 105 compensates for any delay observed in the filtering path due to a delay in the various components of the filtering path, such as the blocker-specific single-channel band pass filter 112. The band pass filter 106 is a wideband band pass filter that trims the spectrum for subsequent signal processing. In the filtering signal path the wanted signal has substantially been eliminated by the blocker-specific single-channel band pass filter 112. Therefore the wanted signal that has been processed in the main receive path is substantially unaffected by the subtraction performed by the signal combiner 107.

An output of the signal combiner 107 is connected to an analogue-to-digital converter 108 which is assumed to be of a delta-sigma type in FIG. 1. Other types of analogue-to-digital converters may be used, as will be illustrated and explained below. The delta-sigma modulator 108 in the receiver arrangement shown in FIG. 1 converts an analogue signal received from the signal combiner 107 to a digital signal that may be processed by a digital signal processor (DSP) 109. Another function of the delta-sigma modulator 108 may be a frequency translation from a radio frequency of the analogue signal to a base band frequency or an intermediate frequency of the digital signal. In a software-defined radio system the DSP 109 may now perform any necessary action to extract one or several wanted signals from a digitised signal generated by the delta-sigma modulator 108. The DSP 109 may also perform one or several functions relating to the quality of the interference signal cancelation achieved by the interference signal cancelation device. For example, the quality of the cancelation process can be assessed by the DSP 109, based upon the level of the residual interference signal remaining in the converted received signal. The DSP 109 adjusts the gain and phase controllers, as required, improving or optimising cancelation of the interference signal. This function of the DSP 109 is performed by a cancelation controller 118 that is a portion of the DSP 109 or a module in the programming of the DSP 109. The cancelation controller 118 has outputs for control signals for the gain/phase controller 117 and the local oscillator 111.

The subtraction of the extracted interference signal from the disturbed signal reduces the level of the interference signal within the disturbed signal to a level that the receiver can cope with. For example, a reduction of the interference signal by about 30 dB (leaving perhaps 70 dB or more before the receiver noise floor), may be sufficient to allow the receiver to cope with the attenuated interference signal.

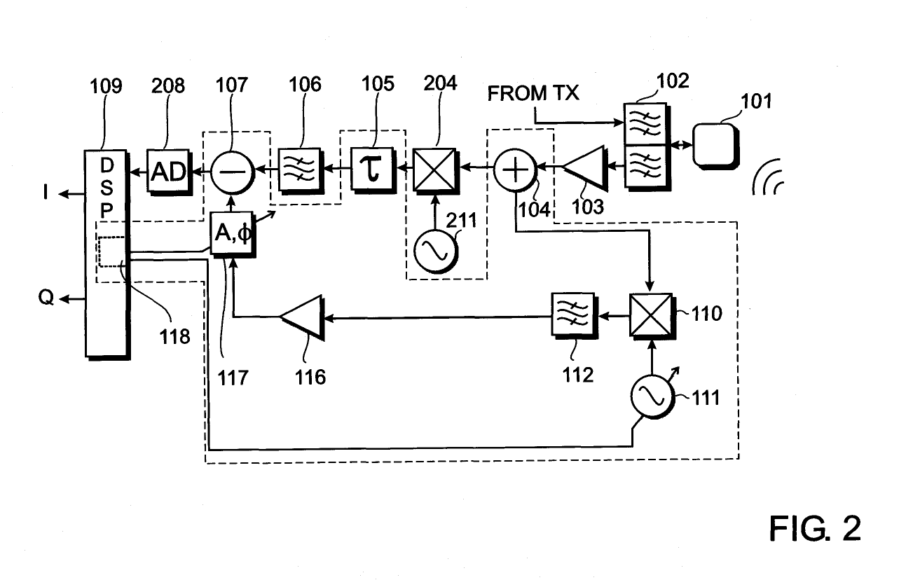

FIG. 2 shows another aspect of the receiver using analogue down conversion and a conventional analogue-to-digital convertor 208 instead of the delta-sigma modulator 108. In the main processing path the signal issued by the signal splitter 104 is fed to a down conversion mixer 204. The down conversion mixer 204 receives a local oscillator signal from a local oscillator 211. As has already been described in relation to FIG. 1, the signal is time delayed by the delay element 105 and wideband filtered by the band pass filter 106. The signal at the output of the signal combiner 107 is fed to the analogue-to-digital convertor 208. The analogue-to-digital convertor 208 provides a digitised signal to the DSP 109.

In the filtering path a signal at an output of the signal filter 104 is down converted in a down conversion mixer 110, as already described before in the context of FIG. 1. Again, as in FIG. 1, the down-converted signal is filtered by a blocker-specific single-channel band pass filter 112 and then amplified by a buffer amplifier 116. The gain/phase controller 117 adjusts a gain and/or a phase of the extracted interference signal which is also called a “cancelation signal” herein.

In the receiver illustrated in FIG. 2, the input to the DSP 109 as well as the subtraction at the signal combiner 107 occurs at the intermediate frequency IF. Performing the subtraction at the intermediate frequency IF removes the need to up-convert the extracted blocker signal, i.e. the cancelation signal, as was necessary in FIG. 1. The intermediate frequency IF to which the disturbed signal is down-converted by the mixers 110 and 204 may be chosen as a function of the centre frequency of the blocker-specific single-channel band pass filter 112. The local oscillator 211 should issue a local oscillator signal that is similar to the local oscillator signal issued by the local oscillator 111, or at least the two local oscillator signals issued by local oscillator 211 and local oscillator 111, respectively, should have substantially the same frequency. As a variant to FIG. 2, it may be possible to combine the two local oscillators 111 and 211 to form a single local oscillator serving the two mixers 110 and 204. A variable intermediate frequency IF may require that any signal processing performed by the DSP 109 needs to be adapted to the current value of the intermediate frequency. Adapting the signal processing of the DSP 109 to the current value of the intermediate frequency IF is expected to be relatively easy. Digital signal processing is often software-defined so that an assignment of a new value to a particular variable is only a matter of storing the new value at a memory location attributed to said particular variable. For example, the variable holding the value of the intermediate frequency IF could be modified in this manner. Therefore, it is expected that the intermediate frequency IF may be chosen in a relatively free manner within boundaries set by the analogue-to-digital converter 208 and the DSP 109.

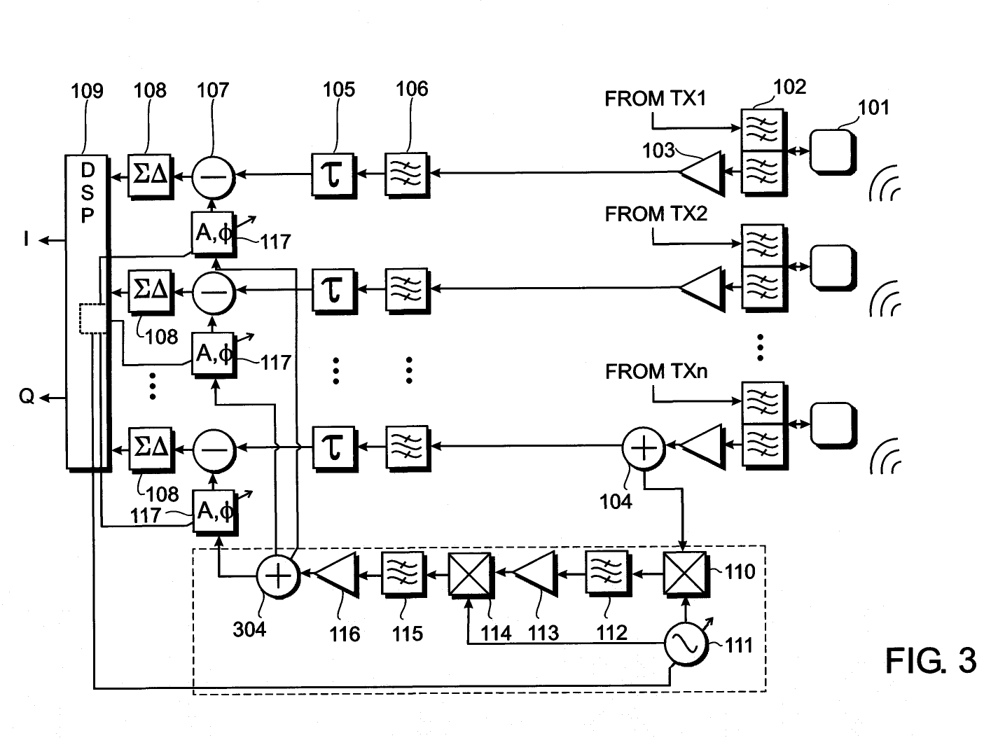

FIG. 3 extends the principle of FIG. 1 to a multi-receiver device, such as that found in an antenna-embedded radio system. The multi-receiver device is connected to an antenna array having n antenna elements. Each antenna element 101 is connected to an individual one of the plurality of receive paths via a plurality of duplex filters 102. The multi-receiver device comprises accordingly n receive paths. The filtering path of the interference signal cancellation device illustrated in FIG. 1 is present once in the multi-receiver device shown in FIG. 3. The filtering path is connected to the signal splitter 104 which is situated in the n'th receiver module of the multi-receiver device. It would also be possible to arrange the signal splitter 104 in any of the other receiver modules 1 to n−1. The elements and the operation of the filtering path are basically the same as for the filtering path in the configuration shown in FIG. 1. Between the buffer amplifier 116 and the gain/phase controller 117 a cancellation signal splitter 304 is inserted. The cancellation signal splitter 304 distributes the cancellation signal to n gain/phase controllers 117. An output of each gain/phase controller 117 is connected to an input of a corresponding signal combiner 107 within each receiver module 1 to n.

With the multi-receiver device shown in FIG. 3, it is only necessary to identify and extract the interference signal once, using one set of interference signal extraction hardware and software. The fact that the processing relative to the interference signal extraction does not need to be duplicated on a per-radio basis may save cost, size and weight. Once the interference signal has been extracted, it can be split and fed to the individual gain/phase controllers 117, for processing and subtraction from each receive path.

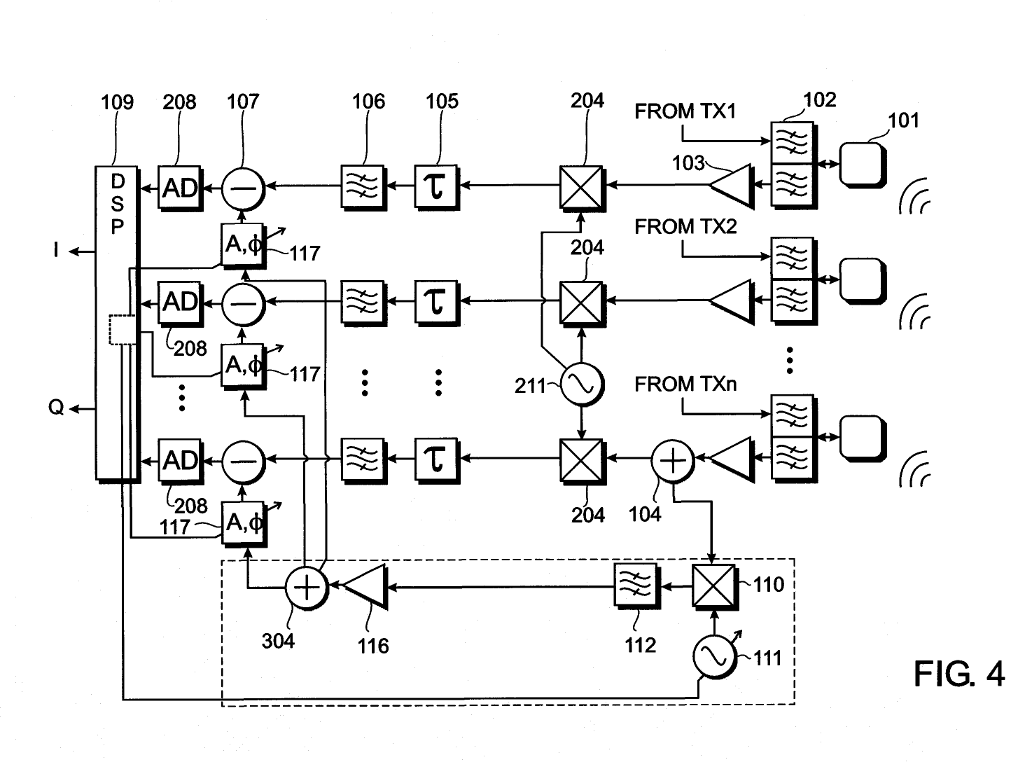

FIG. 4 extends the principles of FIG. 2 to a multi-receiver device, such as that found in an antenna-embedded radio system. As in the multi-receiver device shown in FIG. 3, the filtering path is connected to the signal splitter 104 in the n'th receive path. After down conversion in the mixer 110 and band pass filtering in the blocker-specific single-channel band pass filter 112 the cancelation signal is amplified by the buffer amplifier 116 and distributed to the n receive paths by the signal splitter 304 and a plurality of pairs of gain/phase controllers 117 and signal combiners 107, one pair of gain/phase controllers 117 per receive path. Frequency shifting in the main signal processing paths is performed by n mixers 204 that receive a common local oscillator signal from the local oscillator 211.

As was the case for the multi-receiver device shown in FIG. 3, it is expected that the multi-receiver device shown in FIG. 4 saves cost, size and weight because a substantial part of the filtering path is present only once.

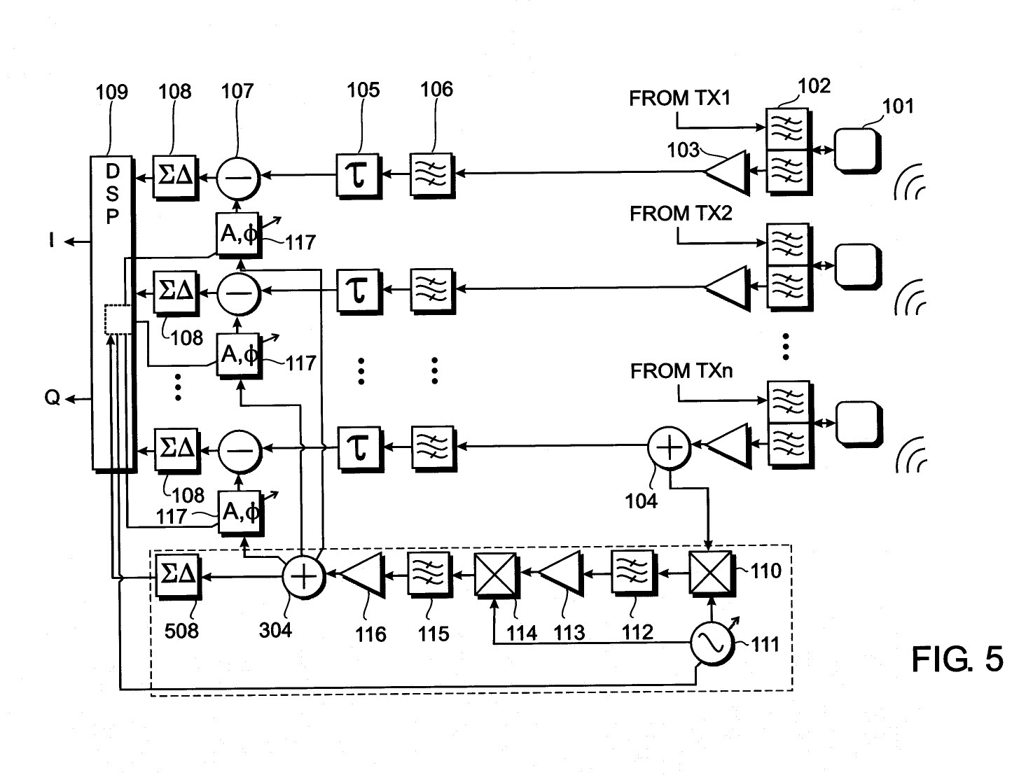

In FIG. 5, a similar multi-receiver device to the multi-receiver device of FIG. 3 is shown. In the configuration of FIG. 5, a further analogue-to-digital conversion channel has been added to the basic multi-receiver device. The further analogue-to-digital conversion channel is connected to an output of the signal splitter 304 and comprises a delta-sigma modulator 508. A delta-sigma modulated signal generated by the delta-sigma modulator 508 is fed to the cancelation controller 118 within the DSP 109. As already mentioned above, the cancellation controller 118 could be a software module that is executed by the DSP 109. The further analogue-to-digital conversion channel allows the extracted interference signal (cancelation signal) to be used for coherent detection/control of the cancellation process in each receive channel. For example, the cancellation controller 118 may compare the cancelation signal with the signals received from the delta-sigma modulator 108 and determine the level of the interference signal that is remaining in the signals received from the delta-sigma modulator 108. The cancelation controller 118 may attempt to improve the cancelation performance by adjusting the gain/phase settings of the gain/phase controllers 117 or by adjusting the local oscillator signal generated by the local oscillator 111, in case the cancellation signal as provided to the cancellation controller 118 via the delta-sigma modulator 508 is still detectable within some or all signals produced by the delta-sigma modulators 108. The cancelation controller 118 may implement an optimisation algorithm, such as successive approximation, solving a system of linear equations, solving a system of non-linear equations, etc.

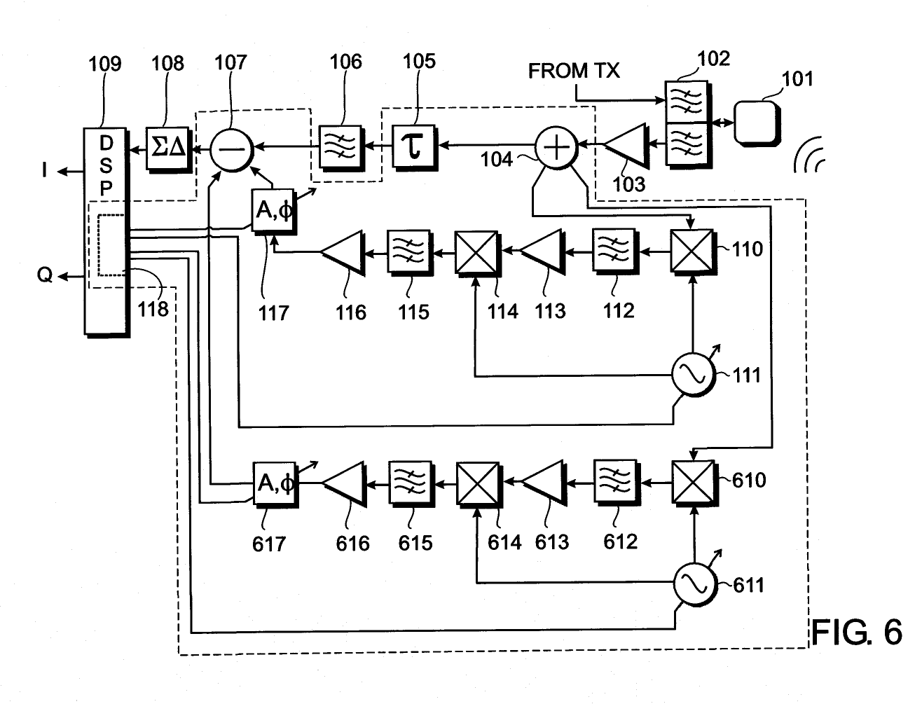

FIG. 6 shows a receiver device with a first interference signal cancellation device and a second interference cancellation device to cancel two different interference signals or blocker signals. The configuration of each interference signal cancellation device is similar to the configuration shown in FIG. 1. An additional blocker cancellation path comprising the second interference cancellation device is connected to the signal splitter 104. The additional blocker cancellation path comprises a down-conversion mixer 611, a blocker-specific single-channel bandpass filter 612, a buffer amplifier 613, an up-conversion mixer 614, a receive band bandpass filter 615, a further buffer amplifier 616, and a gain/phase controller 617. The additional blocker cancellation path is connected to the signal combiner 107. The gain/phase controller 617 receives control signals from the cancellation controller 118 so that the additional blocker cancellation path can be adjusted to cancel a further blocker.

The principle shown in FIG. 6 may be extended to a configuration with a plurality of blocker cancellation paths to cancel a corresponding number of blocker or interference signals. In other words, the signal splitter 104 may distribute the signal received from the LNA 103 to a plurality of blocker cancellation paths.

It is also possible to duplicate or multiply the configurations of the interference cancellation device shown in FIGS. 2 to 5 in a manner analogue to the configuration shown in FIG. 6.

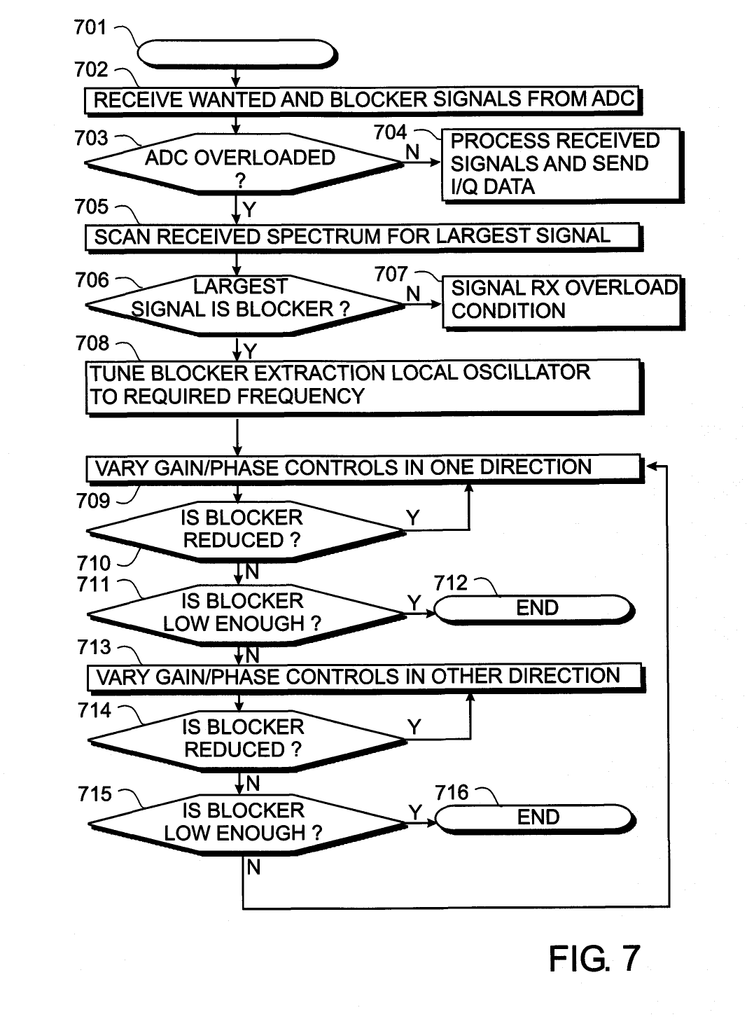

FIG. 7 illustrates one possible algorithm for the identification of an in-band blocker signal. The algorithm starts at a block 701. The DSP 109 receives the in-band blocker signal (if any) and wanted signals from the delta-sigma modulators 108 or 508, or from the analogue-to-digital convertors 208 at a block 702. An in-band blocker signal which does not overload the analogue-to-digital converter or the delta-sigma modulator is not a problem to the system, as this can be dealt with using the usual receiver digital filtering. At a block 703 it is determined whether the analogue-to-digital converter is overloaded. At block 704 the DSP 109 processes the received signals and sends corresponding I/Q data to subsequent components of the base-station if it has been determined at block 703 that the analogue-to-digital converter is not overloaded.

In the opposite case (analogue-to-digital converter is overloaded) a search can be initiated for the largest signal, as this is likely to be the blocker signal, i.e. the strongest interference signal within the frequency range of interest. This search for the largest peak could take many forms, such as a Fast Fourier Transformation (FFT), plus identification of the largest value and identification of its corresponding frequency bin; a scan utilising a digital local oscillator and digital filter, to search for the largest peak, etc. Once the largest signal has been found, a quick assessment can be made, at block 706, whether or not the largest signal is likely to be a blocker signal (e.g. whether it is in the owning-operator's frequency allocation for the product's site—if so, it is unlikely to be a blocker signal). If the largest signal is not a blocker signal, the algorithm goes on to block 707 and signals a receiver overload condition to a failure management system of the base-station, for example.

If it is the case that the largest signal is indeed the blocker signal, then the algorithm continues with block 708 to tune the blocker extraction local oscillator 111 to a frequency required for frequency shifting a centre frequency of the interference signal to a centre frequency of the blocker-specific single-channel band pass filter 112. At the subsequent block 709 the gain and the phase controls are varied in one direction. The effect of this gain/phase variation is checked at a decision point 710. If the strength of the blocker signal could be reduced, then it can be assumed that the gain/phase variation in said one direction leads to better cancelation of the blocker signal. In the contrary case, it might be that the best possible minimum level of a residual blocker signal has already been reached. This is checked at a decision point 711. The algorithm ends at a block 712 if the blocker signal is already low enough. The algorithm continues at a block 713 if the blocker is not yet low enough. At the block 713 it is attempted to vary the gain/phase controls in another direction. Again, it is checked whether the gain/phase variation had a positive effect on the cancelation performance, at a decision point 714. If the blocker signal could be reduced, then the method returns to block 713 in order to perform a further variation of the gain and/or the phase in said other direction. In the other case, the algorithm goes on to a decision point 715 where it is determined whether the blocker signal is already low enough. If the blocker signal is low enough, the algorithm ends at block 716. In the contrary case, the algorithm jumps back to the block 709 to attempt another variation of the gain and/or the phase controls in said one direction.

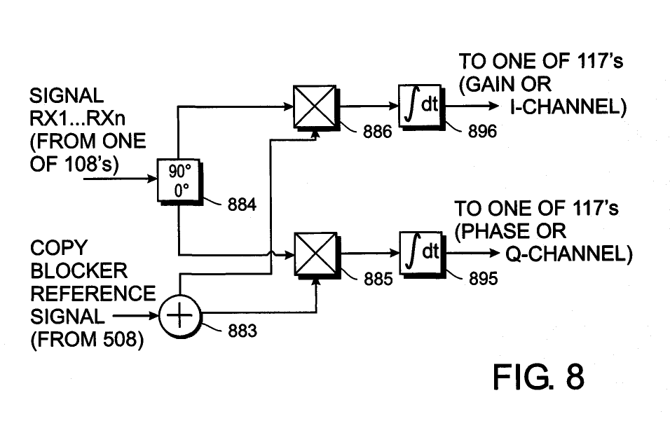

FIG. 8 illustrates the basic DSP processing required in each receive channel in order to detect and minimize the blocker signal in each one of the receivers, prior to analogue-to-digital conversion. The format shown in this figure is based around a quadrature processing system, although it is suitable to control both vector modulator and gain and phase controllers. A vector modulator may be superior to gain and phase controllers from a pull-in perspective.

A phase splitter 884 receives a signal generated by the delta-sigma modulator 108 or the analogue-to-digital convertor 208. In a multi-receiver arrangement such as those shown in FIGS. 3 to 5, the phase splitter 884 receives a signal from a temporarily selected one of the delta-sigma modulators 108 or the analogue-to-digital convertors 208. Temporary selection of the temporarily selected delta-sigma modulator 108 or the temporarily selected analogue-to-digital converter 208 may be achieved by means of e.g. a multiplexer. The phase splitter 884 has a first output providing a 0°-shifted version of the input signal to the phase splitter 884, and a second output providing a 90°-shifted version of the input signal to the phase splitter 884. The first output of the phase splitter 884 is connected to a multiplier 885 and the second output of the phase splitter 884 is connected to a second multiplier 886.

A copy of a blocker reference signal generated by the delta-sigma modulator 508 in the configuration of FIG. 5 is fed to a signal splitter 883. The signal splitter 883 distributes the copy blocker reference signal to the first multiplier 885 and the second multiplier 886. In the two multipliers 885 and 886 a correlation takes place between the copy of the blocker reference signal and the signal received from the delta-sigma modulator 108, i.e. a receive signal. The correlations in the two multipliers 885 and 886 result in two DC signals providing an indication of the amount of the residual blocker signal appearing in the relevant receive channel, that is the receive channel to which the temporarily selected delta-sigma modulator 108 or the temporarily selected analogue-to-digital converter 208 belongs. A first integrator 895 is connected to an output of the multiplier 885, and a second integrator 896 is connected to an output of the multiplier 886. The two integrators 895 and 896 are adapted to steer the I and Q channels in an analogue vector modulator such that the level of residual blocker signal is reduced. An alternative to steering the I and Q channels of the analogue vector modulator is steering the gain and/or the phase of the gain/phase controller 117. In the case of a multi-receiver arrangement (FIGS. 3 to 5) the analogue vector modulator or the gain/phase controller 117 is controlled that is part of a receive path currently controlled by the cancelation controller 118. The n receive paths may be adjusted in a round-robin manner.

Once the level of the residual blocker signal has been eliminated or sufficiently reduced, the two multipliers 885 and 886 will generate a zero DC voltage which will cause the output of the two integrators 895 and 896 to remain constant until such time as the blocker signal's amplitude or phase changes, when the output of the two integrators 895 and 896 will return to their tracking function. Note that any AC signals (e.g. mixer products from the multiplication process) will integrate to zero and hence will have no impact on the control process.

Note that a diversity receiver, such as might be used in a remote radio head application, may be regarded as a special case of a multi-radio system described in this disclosure. In that case, as also in a multi-radio case, it may be possible to set the blocker cancelation signal amplitude only once (i.e. have only a single amplitude controller for the whole system), since a large blocker signal will not have suffered any reflections or multi-path fading (as these would attenuate the signal sufficiently that it would not still constitute “large” in this context). The large blocker signal will, therefore, arrive with the same signal strength at all receiving antennas and only the phase of the signal will be different in each receive channel.

Note also that a variant of this invention could also be used to extract an out-of-band blocker.

While various embodiments of the present invention have been described above, it should be understood that they have been presented by way of example, and not limitation. It will be apparent to persons skilled in the relevant arts that various changes in form and detail can be made therein without departing from the scope of the invention. In addition to using hardware (e.g., within or coupled to a central processing unit (“CPU”), micro processor, micro controller, digital signal processor, processor core, system on chip (“SOC”) or any other device), implementations may also be embodied in software (e.g. computer readable code, program code, and/or instructions disposed in any form, such as source, object or machine language) disposed for example in a computer useable (e.g. readable) medium configured to store the software. Such software can enable, for example, the function, fabrication, modelling, simulation, description and/or testing of the apparatus and methods describe herein. For example, this can be accomplished through the use of general program languages (e.g., C, C++), hardware description languages (HDL) including Verilog HDL, VHDL, and so on, or other available programs. Such software can be disposed in any known computer useable medium such as semiconductor, magnetic disc, or optical disc (e.g., CD-ROM, DVD-ROM, etc.). The software can also be disposed as a computer data signal embodied in a computer useable (e.g. readable) transmission medium (e.g., carrier wave or any other medium including digital, optical, analogue-based medium). Embodiments of the present invention may include methods of providing the apparatus described herein by providing software describing the apparatus and subsequently transmitting the software as a computer data signal over a communication network including the internet and intranets.

It is understood that the apparatus and method describe herein may be included in a semiconductor intellectual property core, such as a micro processor core (e.g., embodied in HDL) and transformed to hardware in the production of integrated sequels. Additionally, the apparatus and methods described herein may be embodied as a combination of hardware and software. Thus, the present invention should not be limited by any of the above-described exemplary embodiments, but should be defined only in accordance with the following claims and their equivalents.

1. An interference cancellation device comprising:
an input for a disturbed signal, the disturbed signal comprising an interference signal,
a first frequency shifter for shifting the disturbed signal from an original frequency range to a filtering frequency range, resulting in a frequency-shifted signal,
a bandpass filter for filtering the frequency-shifted signal, resulting in a cancellation signal, the bandpass filter having a filter bandwidth substantially equal to an expected bandwidth of the interference signal, and
a signal combiner for combining the disturbed signal with the cancellation signal to substantially reduce the interference signal in the disturbed signal.

2. The interference cancellation device according to claim 1, further comprising a second frequency shifter for shifting the cancellation signal from the filtering frequency range to the original frequency range.

3. The interference cancellation device according to claim 1, wherein the first frequency shifter is a mixer.

4. The interference cancellation device according to claim 2, wherein the first frequency shifter and the second frequency shifter are mixers and wherein the interference cancellation device further comprises a local oscillator for supplying a local oscillator signal to the first frequency shifter and the second frequency shifter.

5. The interference cancellation device according to claim 1, further comprising a vector modulator for adjusting at least one of an amplitude and a phase of the cancellation signal.

6. The interference cancellation device according to claim 1, further comprising at least one of a gain controller and a phase controller for adjusting at least one of an amplitude and a phase of the cancellation signal.

7. The interference cancellation device according to claim 6, further comprising a cancellation controller for adjusting at least one of an amount of frequency shift performed by the first frequency shifter, a gain setting of the gain controller, and a phase setting of the phase controller.

8. The interference cancellation device according to claim 7, wherein the cancellation controller comprises an input for the cancellation signal.

9. The interference cancellation device according to claim 8, wherein the cancellation controller comprises a correlator for correlating the cancellation signal and a signal originating from the signal combiner.

10. The interference cancellation device according to claim 9, wherein the correlator is a one of a quadrature correlator, a polar correlator, and a polar detector.

11. The interference cancellation device according to claim 1, further comprising a cancellation controller for adjusting an amount of frequency shift performed by the first frequency shifter.

12. The interference cancellation device according to claim 11, wherein the cancellation controller comprises an input for the cancellation signal.

13. The interference cancellation device according to claim 12, wherein the cancellation controller comprises a correlator for correlating the cancellation signal and a signal originating from the signal combiner.

14. The interference cancellation device according to claim 13, wherein the correlator is a quadrature correlator.

15. The interference cancellation device according to claim 1, further comprising a signal splitter for distributing the cancellation signal to a plurality of signal processing paths subject to a similar or identical interference signal.

16. The interference cancellation device according to claim 1, wherein the interference signal is an in-band blocker.

17. The interference cancellation device according to claim 1, wherein the interference signal is an out-of-band blocker.

18. The interference cancellation device according to claim 1, wherein a ratio between the bandwidth of the interference signal and a bandwidth of the disturbed signal is between 0.5% and 1%.

19. The interference cancellation device according to claim 1, wherein the bandwidth of the interference signal is between 150 kHz and 300 kHz, and wherein the bandwidth of the disturbed signal is between 30 MHz and 40 MHz.

20. The interference cancellation device according to claim 1, further comprising a cancellation signal splitter and additional signal combiners for combining the cancellation signal with other disturbed signals comprising similar or identical interference signals to substantially reduce the similar or identical interference signals in the other disturbed signals.

21. A method for interference cancellation on a disturbed signal comprising an interference signal, the method comprising:
frequency shifting the disturbed signal from an original frequency range to a filtering frequency range, resulting in a frequency-shifted signal,
bandpass filtering the frequency-shifted signal, resulting in a cancellation signal, wherein a bandwidth of the bandpass filtering substantially matches an expected bandwidth of the interference signal, and
combining the disturbed signal with the cancellation signal to substantially reduce the interference signal in the disturbed signal.

22. A computer program product embodied on a computer-readable medium and the computer-readable medium comprising executable instructions for the manufacture of an interference cancellation device comprising:
an input for an disturbed signal, the disturbed signal comprising an interference signal,
a first frequency shifter for shifting the disturbed signal from an original frequency range to a filtering frequency range, resulting in a frequency-shifted signal,
a bandpass filter for filtering the frequency-shifted signal, resulting in a cancellation signal, the bandpass filter having a filter bandwidth substantially matching an expected bandwidth of the interference signal, and
a signal combiner for combining the disturbed signal with the cancellation signal to substantially reduce the interference signal in the disturbed signal.

23. A computer program product comprising instructions that enable a processor to carry out a method comprising:
frequency shifting the disturbed signal from an original frequency range to a filtering frequency range, resulting in a frequency-shifted signal,
bandpass filtering the frequency-shifted signal, resulting in a cancellation signal, a bandwidth of the bandpass filtering substantially matching an expected bandwidth of the interference signal,
combining the disturbed signal with the cancellation signal to substantially reduce the interference signal in the disturbed signal.
